(19) United States
(12) Patent Application Publication
(10) Pub. No.: US 2014/0356488 A1
(43) Pub. Date: Dec. 4, 2014

(54) CONTAINER FOR DRY GOODS

(71) Applicant: Rachel Dadush, Shoham (IL)

(72) Inventor: Rachel Dadush, Shoham (IL)

(21) Appl. No.: 14/368,805

(22) PCT Filed: Jan. 20, 2013
(86) PCT No.: PCT/IL2013/050057

§ 371 Date: Jun. 26, 2014

Related U.S. Application Data
(60) Provisional application No. 61/593,884, filed on Feb. 2, 2012.

(51) Int. Cl. B65D 77/04; A23L 1/164; B65D 47/36; B65B 1/04; B65B 55/00

(52) U.S. Cl. CPC B65D 77/0473; B65B 1/04; B65B 55/00; B65D 47/36; A23L 1/1646
USPC 426/122; 53/449; 426/106

(57) ABSTRACT

A method of packaging dry goods comprises filling a bag with dry goods; hermetically sealing the bag; attaching a neck portion to the bag; placing the bag within cardboard packaging; pressing the neck portion through the cardboard packaging to penetrate through to the outside; and attaching a cap on the neck portion from the outside.

### FIELD AND BACKGROUND OF THE INVENTION

The present invention, in some embodiments thereof, relates to a container for dry goods with a conveniently removable cap, and, more particularly, but not exclusively, to a container for dry goods where the goods are contained in an inner bag within the container which is initially hermetically sealed.

Dry goods such as breakfast cereals, are often contained in cardboard boxes and, within the cardboard boxes are further contained in a hermetically sealed inner bag. In general the cardboard box is closed with cardboard flaps and, after opening the inner bag is not closed at all. Thus after opening, the dry goods are exposed to spillage and to atmospheric moisture and are not protected at all.

Milk cartons, which are cardboard containers having plastic necks and screw on caps are known. After initial opening the cap can be replaced to close the container and keep the milk fresh. However the system used for milk cartons cannot be transferred to containers for dry goods due to the use of the inner bag. The goods are inside a separate bag and thus not accessible through the cap and neck. Yet if the bag is initially attached to the cap and the neck then the difficulty arises of placing the bag inside the cardboard container such that the cap and neck protrude.

The current art consists of a number of innovations. In one solution a bag is attached via an opening to a neck, which neck is then fitted on the carton. Examples include WO2006051284 and U.S. Pat. No. 7,681,783. These have in common that the bag is not hermetically sealed.

FIG. 7 illustrates a solution shown in US 2001 147 442 in which a carton contains an inner liner that adheres to the wall of the carton. A closable opening allows goods within the lining to be poured out. However the inner lining does not constitute a bag that can be hermetically sealed.

US 2008006680 dispenses with the inner bag and encloses cereals directly within the carton. The teaching is shown in FIG. 8. The carton is hermetically sealed.

WO 2004024590 teaches a dispensing tube equipped bag and a container with a pour spout, for liquids or powders and in a hermetic seal is provided. As disclosed, the bag or pouch is filled with dry goods when already located within the carton, which is an awkward operation, and the hermetic or near hermetic seal is provided by closure of the carton. The bag itself is not hermetically sealed at all. During the process of filing the bag a delivery tube is produced which the user then attaches to a spout in order to pour the product.

Thus none of the above disclosures teach any way combining a hermetically sealed bag within a carton with a way of having the bag attached to a closure on the outer carton for pouring of the goods.

### SUMMARY OF THE INVENTION

According to an aspect of some embodiments of the present invention there is provided a method of packaging dry goods comprising:

filling a bag with the dry goods;

hermetically sealing the bag;

attaching a neck portion to the bag;

placing the bag within an outer packaging;

pressing the neck portion through the outer packaging to penetrate through the outer packaging to an outside of the outer packaging; and

attaching a cap on the neck portion from the outside of the outer packaging.

An embodiment may involve using a wall of the neck portion to pierce the outer packaging.

An embodiment may involve providing a perforation on the outer packaging around a region designated for the penetration.

In an embodiment, the neck comprises a thread and the cap comprises a complementary thread for screw-on replacement.

An embodiment may comprise folding the outer packaging to have a base and walls substantially at right angles and having a sloping upper portion, the penetration being at the sloping upper portion.

In an embodiment, the attaching of a neck portion to the bag is carried out prior to hermetically sealing the bag or prior to filling the bag with dry goods.

In an embodiment, the attaching of a neck portion to the bag is carried out after hermetically sealing the bag.

In an embodiment, the attaching of the neck portion to the bag comprises using at least one member of the group consisting of an adhesive and welding.

An embodiment may comprise attaching the neck portion such that a portion of a surface of the bag under the neck is held taut.

In an embodiment, the attaching of the neck portion to the bag comprises providing an attachment sufficiently strong that pushing against the bag through the neck portion causes piercing of the bag in preference to detachment of the bag.

According to a second aspect of the present invention there is provided a containment system for holding dry goods comprising:

an outer packaging;

an inner packaging being sealed and holding the dry goods within, the inner packaging freely located within the outer packaging;

a neck portion adhered to the inner packaging and penetrating the outer packaging; and

a closure closing the neck portion from outside the outer packaging.

In an embodiment, a portion of the inner packaging under the neck portion is taut.

In an embodiment, the neck is adhered to the inner packaging sufficiently strongly that pushing against the inner packaging through the neck portion causes piercing of the inner packaging in preference to detachment of the inner packaging.

In an embodiment, the outer packaging comprises a perforation around the neck portion.

In an embodiment, the neck portion and the closure comprise complementary threads for closing.

In an embodiment, the outer packaging comprises a substantially rigid structure having walls and a base portion at substantially right angles to each other, the outer packaging further comprising a sloping upper surface, the neck portion penetrating through the sloping upper portion.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified cut-away drawing showing a perspective view of a container with a bag inside, according to embodiments of the present invention;

FIG. 2 is a simplified diagram showing a bag for use with the embodiment of FIG. 1;

FIG. 3 is a simplified diagram showing a side view of the container of FIG. 1;

FIG. 4 is a perspective view of the container of FIG. 1 seen from outside as a solid shape;

FIG. 5 is a view of a front sloping portion of the container of FIG. 4;

FIG. 6 is a simplified view from the front of the container of FIG. 4;

FIG. 7 is a prior art container system having a liner inside a carton;

FIG. 8 is a prior art container system in which dry goods are placed directly in a carton; and

FIG. 9 is a simplified flow chart showing a process for manufacturing and filling a container system according to the present embodiments.

### DESCRIPTION OF SPECIFIC EMBODIMENTS OF THE INVENTION

The present invention, in some embodiments thereof, relates to a container for dry goods with a conveniently removable cap, and, more particularly, but not exclusively, to a container for dry goods where the goods are contained in an inner bag within the container which is initially hermetically sealed.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

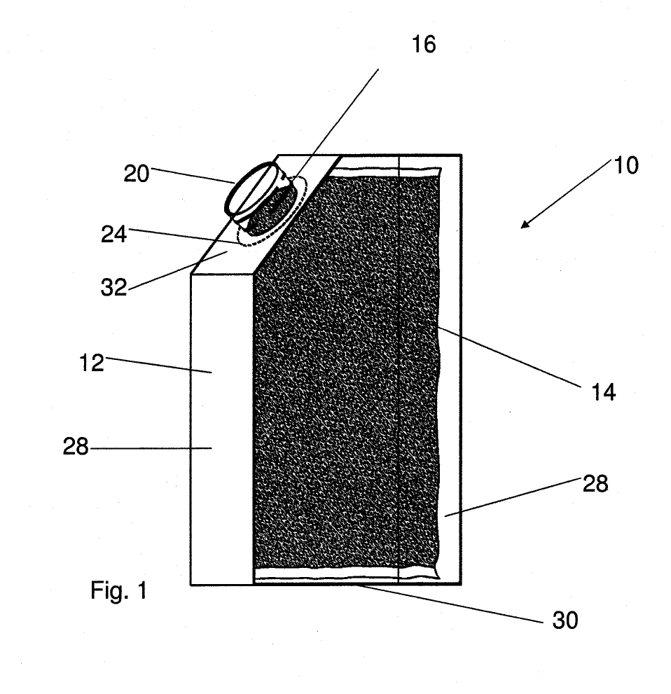

Referring now to the drawings, FIG. 1 illustrates a containment system 10 for holding dry goods. The containment system 10 includes an outer packaging 12, typically in the form of a carton. Within the outer packaging 12 is an inner packaging 14 which is sealed, initially hermetically, and which holds the dry goods within. The inner packaging is freely located within the outer packaging, and is typically not glued, folded or otherwise attached to the body of the outer packaging.

A neck portion 16 is adhered to the inner packaging and penetrates through the outer packaging 12. A closure 20 closes the neck portion from outside of the outer packaging 12.

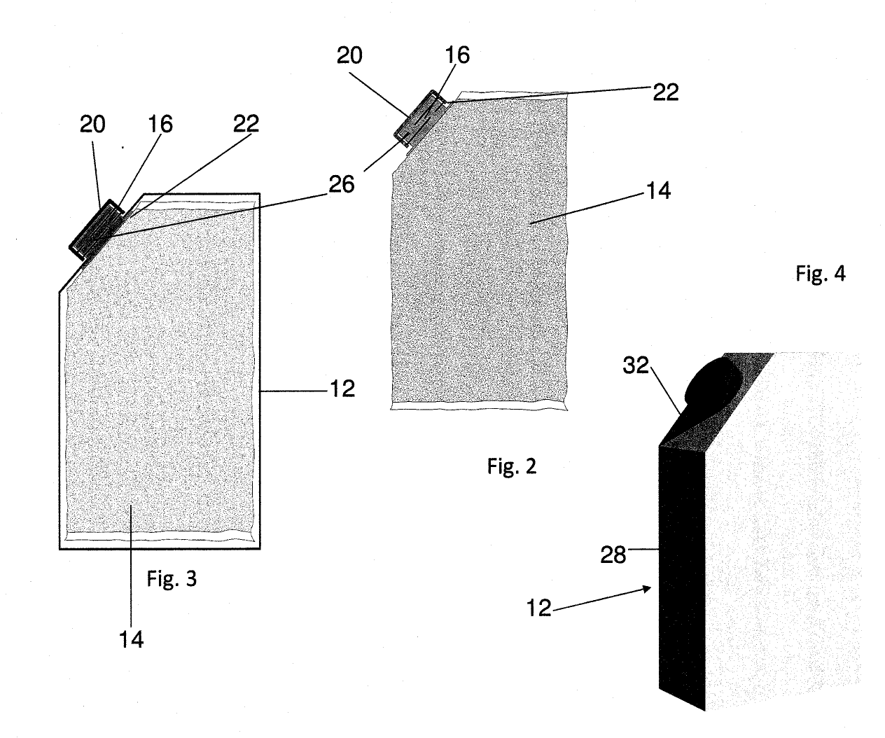

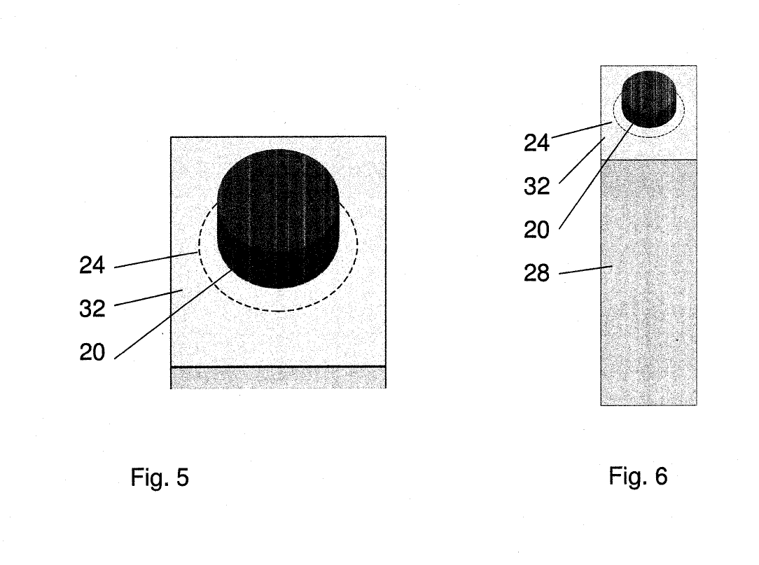

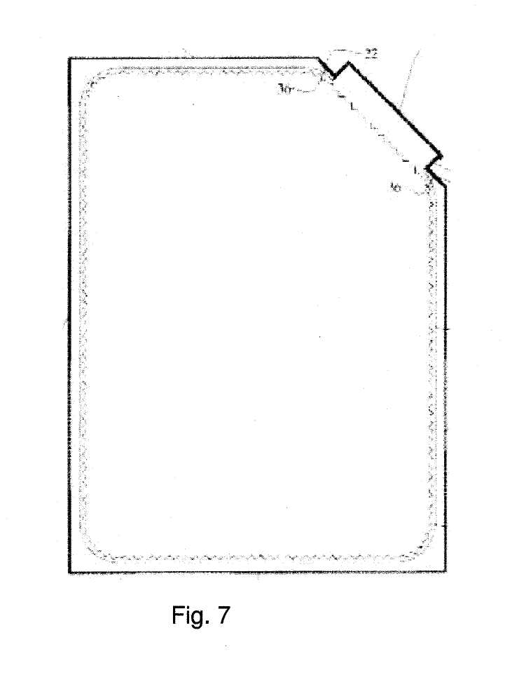

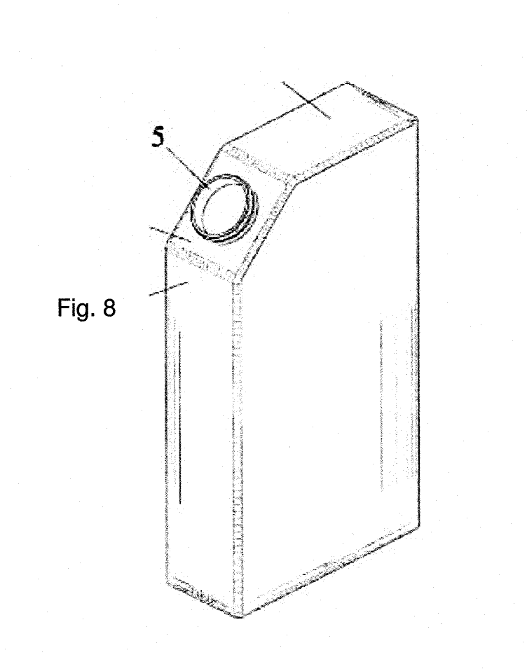

FIG. 2 illustrates the inner packaging 14. Neck portion 16 adheres directly to the inner packaging 14 via an attachment flange 22, and closure 20 closes the neck portion from outside. A portion of the inner packaging 14 which is under the flange 22 and the neck portion 16 may be held taut, so that when a user opens the closure 20 he/she is able to pierce the bag, break the hermetic seal and pour the goods.

In an embodiment, the neck and flange are adhered to the inner packaging sufficiently strongly that pushing against the inner packaging through the neck portion causes piercing of the inner packaging, rather than detachment of the inner packaging from the neck.

The outer packaging 12 comprises a perforation 24 around the neck portion. The perforation allows the neck, cap and bag, typically plastic components, to be detached from the outer packaging, which is typically a cardboard component, for the purposes of recycling.

As shown in FIGS. 2 and 3, the neck portion 18 and the closure may comprise complementary threads 26 for closing. As an alternative, the closure may be snap fitted onto the neck via a flange, or other closure systems known in the art may be used to provide a securely replaceable cap.

The outer packaging 12 is typically a box or more generally a hollow polyhedron with a substantially rigid structure having walls 28 and a base portion 30 at substantially right angles to each other. The outer packaging may have a sloping upper surface 32 which provides a pouring region. The neck portion 16 penetrates through the sloping upper portion 32.

In an alternative version there may be two sloping portions on either side of the outer packaging so that the upper portion of the outer packaging forms an inverted ‘V’ shape, as is known with drinks cartons.

As shown in FIG. 2, the bag may be shaped to have a corresponding sloping portion for easy fitting within the container. An advantage of such a shape is that it prevents the bag from inadvertently being filled without allowing the contents to settle. A bag filled with the dry goods that are not settled into the bag may not fit within the outer packaging without crushing the dry goods.

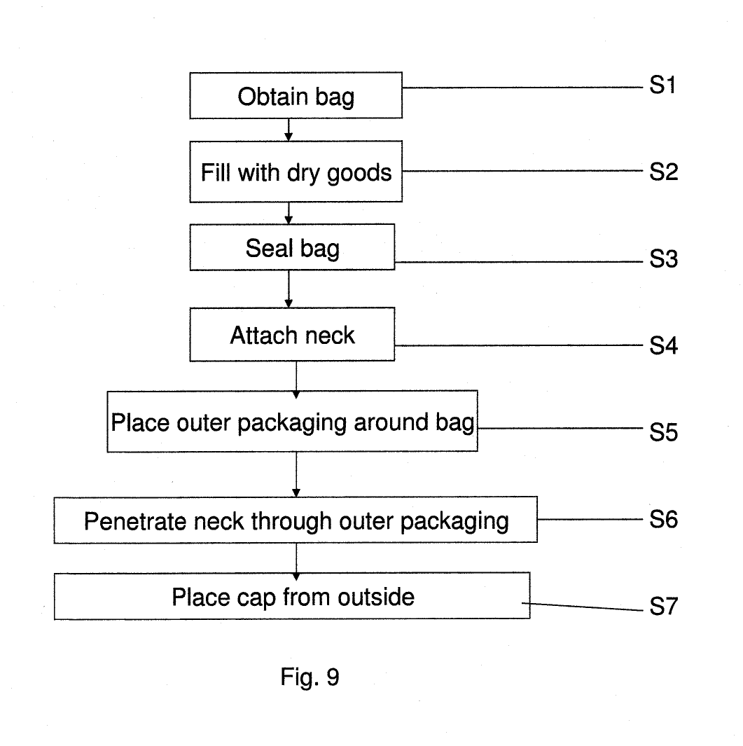

Reference is now made to FIG. 9, which is a simplified flow chart illustrating a process for manufacturing the storage system of the present embodiments and packaging the dry goods.

Initially a plastic bag is extracted from a roll—S1. The bag is then filled with the dry goods, S2. The bag is then hermetically sealed, S3. A neck portion is then adhered to the bag via a flange using adhesive, S4.

The outer packaging is either folded into shape around the bag or the bag is placed within the partially formed outer packaging, S5.

The neck is now inside the outer packaging along with the bag. The neck is now made to penetrate the outer packaging at a selected point, S6 and then the cap is closed onto the neck from outside the outer packaging, S7.

Typically, the upper end of the circular wall of the neck portion pierces the packaging.

In an embodiment, attaching of a neck portion to the bag may be carried out prior to hermetically sealing the bag, or prior to filling with dry goods. That is to say, stage S4 in FIG. 9 is transferred to be either prior to S3 or prior to S2.

Typically, attaching of the neck portion to the bag comprises using adhesive or heat sealing—welding. However any other method may be considered provided that the attachment is sufficiently strong that pushing against the bag through the neck portion causes piercing of the bag in preference to detachment of the bag from the neck.

The user buys the container with the goods clearly sealed in tamper evident manner The container is opened by removing the cap and then piercing the bag through the neck. If the neck is already pierced the user knows not to accept the bag.

The user then pours the dry goods as desired and replaces the cap to keep the remainder of the goods dry and fresh until next required. The cap properly replaced protects against accidental spillage.

After use the container system can be separated into plastic and cardboard parts by tearing at perforation 24, so that each part can be placed in the appropriate collection for recycling.

It is expected that during the life of a patent maturing from this application many relevant storage systems will be developed and the scope of the corresponding terms are intended to include all such new technologies a priori.

The terms “comprises”, “comprising”, “includes”, “including”, “having” and their conjugates mean “including but not limited to”.

As used herein, the singular form “a”, “an” and “the” include plural references unless the context clearly dictates otherwise. For example, the term “a compound” or “at least one compound” may include a plurality of compounds, including mixtures thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of packaging dry goods comprising:
filling a bag with said dry goods;
after said filling, hermetically sealing said bag;
after said hermetically sealing, attaching a neck portion to said bag, wherein said neck portion comprises a wall and an attachment flange;
placing said bag within an outer packaging;
piercing said outer packaging with an upper end of said wall of said neck portion to penetrate through said outer packaging to an outside of said outer packaging; and
attaching a cap on said neck portion from said outside of said outer packaging.

2. The method of claim 1, wherein said upper end of said wall of said neck portion is circular.

3. The method of claim 1, further comprising providing a perforation on the outer packaging around a region designated for said penetration.

4. The method of claim 1, wherein said neck comprises a thread and said cap comprises a complementary thread for screw-on replacement.

5. The method of claim 1, comprising folding said outer packaging to have a base and walls substantially at right angles and having a sloping upper portion, said penetration being at said sloping upper portion.

6-7. (canceled)

8. The method of claim 1, wherein said attaching of said neck portion to said bag comprises using at least one member of the group consisting of an adhesive and welding.

9. The method of claim 8, further comprising attaching said neck portion such that a portion of a surface of said bag under said neck is held taut.

10. The method of claim 8, wherein said attaching of said neck portion to said bag comprises providing an attachment sufficiently strong that pushing against said bag through said neck portion causes piercing of said bag in preference to detachment of said bag.

11. A containment system for holding dry goods comprising:
an outer packaging;
an inner packaging being hermetically sealed and holding said dry goods within, said inner packaging freely located within said outer packaging;
a neck portion comprising a wall and an attachment flange, wherein said attachment flange is adhered to said inner packaging and said wall pierces through said outer packaging; and
a closure closing said neck portion from outside said outer packaging.

12. The containment system of claim 11, wherein a portion of said inner packaging under said neck portion is taut.

13. The containment system of claim 12, wherein said neck is adhered to said inner packaging sufficiently strongly that pushing against said inner packaging through said neck portion causes piercing of said inner packaging in preference to detachment of said inner packaging.

14. The containment system of claim 11, wherein said outer packaging comprises a perforation around said neck portion.

15. The containment system of claim 11, wherein said neck portion and said closure comprise complementary threads for closing.

16. The containment system of claim 11, wherein said outer packaging comprises a substantially rigid structure having walls and a base portion at substantially right angles to each other, said outer packaging further comprising a sloping upper surface, said neck portion penetrating through said sloping upper portion.
